(19) United States
(12) Patent Application Publication
(10) Pub. No.: US 2022/0198480 A1
(43) Pub. Date: Jun. 23, 2022

(54) SYSTEMS AND METHODS FOR GENERATING AN OPTIMAL ALLOCATION OF MARKETING INVESTMENT

(71) Applicant: KEEN DECISION SYSTEMS, INC., Durham, NC (US)

(72) Inventor: John BUSBICE, Durham, NC (US)

(21) Appl. No.: 17/669,771

(22) Filed: Feb. 11, 2022

Related U.S. Application Data
(63) Continuation of application No. PCT/US21/63677, filed on Dec. 16, 2021.
(60) Provisional application No. 63/127,625, filed on Dec. 18, 2020.

(51) Int. Cl. G06Q 30/02; G06Q 40/06

(52) U.S. Cl. CPC G06Q 30/0201; G06Q 40/06

(57) ABSTRACT

Systems and methods for generating an optimal allocation of marketing investment for a marketing budget based on a marketing variable without requiring historical time-series data or survey data are disclosed. A first advertising elasticity is determined for the marketing variable based on a meta-analysis of a normative database. A second advertising elasticity is determined based on financial data for the offering being analyzed. The first and second advertising elasticities are combined to determine the optimal allocation.

### CROSS-REFERENCE TO RELATED APPLICATIONS

This application is a continuation application of PCT Application No. PCT/US2021/063677 filed on Dec. 16, 2021, by Keen Decision Systems, Inc., titled “SYSTEMS AND METHODS FOR GENERATING AN OPTIMAL ALLOCATION OF MARKETING INVESTMENT,” which claims priority to U.S. Provisional Patent Application No. 63/127,625 filed on Dec. 18, 2020, by Keen Decision Systems, Inc., titled “SYSTEMS AND METHODS FOR GENERATING AN OPTIMAL ALLOCATION OF MARKETING INVESTMENT,” the entire contents of all of which are incorporated by reference herein.

### TECHNICAL FIELD

The systems and methods described herein relate to generating a new data model for allocating marketing budget. More specifically, they relate to generating an optimal allocation of marketing investment for a marketing budget based on a marketing variable without requiring historical time-series data or survey data.

### BACKGROUND

There are many different marketing tactics a company may use for advertising of a product or brand. When faced with the possibility of multiple marketing tactics, companies must determine the best way to spend their marketing budget. Determining how to most effectively allocate marketing budget involves numerous factors.

Advertising elasticity can be thought of as a measure of the effectiveness of a particular advertising investment, and it refers to an expected proportional change in revenue for a proportional change in investment in a marketing activity. Estimates of advertising elasticity for a proposed advertising tactic may be determined using a Bayesian statistical model that includes prior estimates of advertising elasticity. The advertising elasticity of a proposed course of action may be calculated as a probability distribution based on prior estimates of advertising elasticity.

Traditionally, the process of allocating marketing budget based on known advertising elasticity requires historical time-series data from a user seeking to allocate their marketing budget about previous marketing tactics and their outcomes. In many cases, such historical time-series data either does not yet exist or, if it does exist, would be too burdensome to input such that it can be analyzed in a meaningful way.

One approach that has been used is to incorporate survey data (e.g., data from survey-based assessments) from the user to adjust the existing normative data to the business context. Others have proposed a process of using survey data with the normative database to elicit estimates of market elasticity. This survey-data approach has similar problems to the historical time-series data approach, in that gathering and/or inputting the survey data such that it can be analyzed in a meaningful way would likewise be too burdensome.

Accordingly, a need exists for a way to determine an optimal allocation of marketing budget that generates an actionable model that does not require taking into account historical time-series data or survey data.

### SUMMARY

The methods and systems described herein provide a so-called quick-start method and a corresponding quick-start system for implementing the quick-start method in which an optimal allocation of marketing budget is generated without requiring the use of historical time-series data or survey data for the marketing activity being analyzed. It is referred to as “quick-start” because it generates actionable data for a user quickly and without requiring the burdensome process of inputting large amounts of data as a prerequisite for generating the actionable data. The quick-start methods and systems described herein generate a data model that provides an optimized allocation for marketing budget that is determined based on existing normative data and financial data related to the brand for which the marketing activity is being analyzed.

Traditionally, two types of data have been used to generate an allocation for marketing budget. The first of the two types of data that are traditionally used to generate an allocation for marketing budget is financial data, which is data relating to the amount of sales that has been generated in the past from the offering being analyzed and the amount of money that has been spent to achieve those sales amounts. The second of the two types of data that are traditionally used to generate an allocation for marketing budget is historical time-series data for the offering being analyzed, which is data relating to the number of exposures for a given time period (e.g., per week or month) and the corresponding sales volume for the offering being analyzed.

Traditional methods of using these data, known as marketing mix modeling, involve estimating a demand equation using econometric methods. The elasticity is estimated using multiple regression to infer these quantities. The regression uses the sales over time as the response variable and the activity over time as the regressors. Additional data to account for other factors such as seasonality, other company activities such as pricing, and competition may also be incorporated. Once the model is estimated, the change in sales due to the change in investment is calculated by applying the financial data to the estimated demand equation.

The quick-start methods and systems described herein provide a practical application in that they provide quick estimates of valuable information that can be used for planning purposes and/or quick decision making without the need for time-series or survey data, which often have high input costs. Thus, the quick-start methods and systems described herein provide for previously unavailable data that opens a new avenue of analysis to decision makers. In many cases, a user may want a quick estimate of an allocation for a marketing budget without having to gather and/or input lots of historical time-series data and/or survey data. Such quick estimates may be used for quickly valuing competing strategies before committing additional resources to further investigating those competing strategies. Such quick estimates also may be used where the traditional historical time-series data and/or survey data is unavailable. In these cases, existing methods and computer systems that implement the existing methods lack the ability to provide these types of quick estimates.

The quick-start methods and systems described herein improve on the existing technology for allocating marketing budget by generating an optimal allocation for marketing budget without requiring historical time-series data or survey data from the user. Instead, an optimal allocation is generated without requiring historical time-series data or survey data by analyzing (1) normative data (i.e., using meta-analysis); and (2) financial data (i.e., profit and loss statements) to estimate the demand model. It should be noted here, and it will be appreciated by those having ordinary skill in the art, that historical time-series data and/or survey data may be used in addition to the normative data and financial data as described herein. One advantage of the methods and systems described herein is that the historical time-series data and survey data are no longer required; however, they need not be excluded from the analysis entirely. These methods and systems produce a demand model that may later be further updated with historical time-series data and/or survey data if and/or when that data is available.

The quick-start system described herein is a computing system that provides a user with data relating to an optimal allocation of marketing investment based on the user's input relating to an offering. This includes an optimal allocation of marketing investment, a forecast associated with that investment, the value of that investment, and an econometric model that can be validated and updated with observation data.

### BRIEF DESCRIPTION OF THE DRAWINGS

FIG. 1 depicts an exemplary configuration of a normative database.

FIG. 2 depicts an exemplary process flow for a method of generating an allocation of resources to a total marketing budget for a particular offering.

FIG. 3 depicts an exemplary system for implementing the method described in FIG. 2.

FIG. 4 depicts an exemplary process flow for a method of generating an allocation of marketing investment for a marketing budget based on a marketing variable without requiring historical time-series data or survey data for the marketing variable.

FIG. 5 depicts a block diagram illustrating one embodiment of a computing device that implements the methods and systems for generating an optimal allocation of marketing investment described herein.

### DETAILED DESCRIPTION

The following description and figures are illustrative and are not to be construed as limiting. Numerous specific details are described to provide a thorough understanding of the disclosure. In certain instances, however, well-known or conventional details are not described in order to avoid obscuring the description. References to “one embodiment” or “an embodiment” in the present disclosure may be (but are not necessarily) references to the same embodiment, and such references mean at least one of the embodiments.

Reference in this specification to “one embodiment” or “an embodiment” means that a particular feature, structure, or characteristic described in connection with the embodiment is included in at least one embodiment of the disclosure. Multiple appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

As explained above, an optimal marketing allocation is generated without requiring historical time-series data or survey data by analyzing (1) normative data (i.e., using meta-analysis); and (2) financial data (i.e., profit and loss statements) to estimate the demand model. The normative data used to generate the optimal marketing allocation may be stored in a normative database.

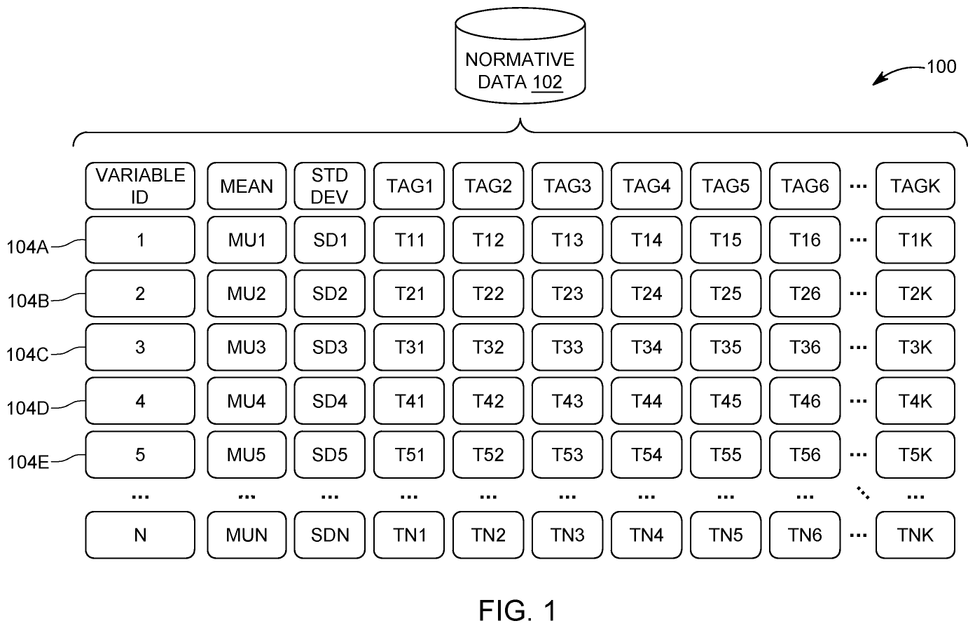

FIG. 1 depicts an exemplary configuration of a normative database.

Referring to FIG. 1, the exemplary normative database 102 stores a plurality of records 104A-104E, which include estimates of advertising elasticity as well as additional data relating to the estimates of advertising elasticity. Each record or row 104 of the database 102 represents a probabilistic estimate for advertising elasticity, described by the mean and standard deviation, for a particular Variable. Each record or row 104 also contains text tag data that relates to the Variable. Each Variable (i.e., record or row) may be any particular aspect of an advertising or marketing tactic, such as, for example, “Social Video,” “YouTube,” “Network Television,” or “Unbranded Search.”

Each row 104 in the exemplary normative database 102 includes a “Variable ID” field. The Variable ID is a unique key for the row. Each row 104 represents an estimate of advertising elasticity for the Variable represented by the row from any number of sources, which include but are not limited to models that have been input by users, generated by users, or generated as a part of academic literature.

Each row 104 in the exemplary normative database 102 includes a “Mean” field. The Mean is an estimate of the advertising elasticity for the particular Variable represented by that row. In other words, for a row for a “Social Video” Variable, the Mean value represents a point estimate of the advertising elasticity for “Social Video” based on a previous estimate of advertising elasticity for a social video tactic.

Each row 104 in the exemplary normative database 102 includes a “Std Dev” field, which refers to the standard deviation around the mean (i.e., the “Mean” field) of the advertising elasticity.

The exemplary normative database 102 comprises a number of tags, which provide additional datapoints for each Variable in the database. Each row 104 in the exemplary normative database 102 includes one or more “Tag” fields, which may be represented, for example, as Tag₁ . . . Tagₖ. The “Tag₁” through “Tagₖ” fields contain each of the tags that are included in the normative database. The tags describe or otherwise relate to various particular aspects of the Variable represented by a particular row. The tags may be words, names, phrases, or other descriptors that describe the particular advertising activity being represented by the row. The tags may be text descriptors, for example: “Trade,” “TV,” “Online,” “Search,” “Paid,” “YouTube,” “Walmart,” “Programmatic,” or the like. These tags may be curated collaboratively between curators for the system and users of the system. In addition to the text descriptor, each tag within each record may be assigned an indicator, for example, where a 1 (or TRUE) indicates that the tag is present in the user's description, and a 0 (or FALSE) indicates otherwise (e.g., that the tag is not present in the user's description).

In addition, the exemplary normative database 102 may comprise one or more metrics for tracking data related to Variables. The metrics may include trackable data, such as likes, views, impressions, clicks, spend, or the like.

The normative database 102 may be populated with data in various ways. One way for data to be entered into the normative database is where a user enters the data (e.g., text data) into the normative database via a graphical user interface. For example, the user may enter a name for a variable to be used in the analysis (e.g., “Social Video”), a text description of the variable (e.g., “Boosted video ads shared on social media sites”), and any metrics associated with the variable (e.g., “Likes,” “Impressions,” or “Spend”).

To generate tags from the user-input data, the system generates keywords based on the user's input for the Variable. For example, the system may parse the text of the name of the Variable, the description of the Variable, and the metrics associated with the Variable. This text parsing generates one or more tags that represent the parsed values. The generated tags may then be further enhanced with one or more second-level meta-tags. At this point, the user may be presented with an option to add, modify, or delete any of the one or more tags associated with the variable that were generated by the system.

Another way for data to be entered into the normative database 102 is through data curators. Existing data may be entered into the normative database 102 manually by admin users of the system. These may be primary tags or second-level meta-tags. The existing data may be entered manually, or it may be imported from another electronic file, such as a data table, a .csv file, an Excel® spreadsheet file, another database, or the like. The existing data may come from academic journals that publish studies relating to advertising elasticity, such as an elasticity table. For example, an academic journal may publish a study along with the corresponding research data used for the study. The research data may be published in the form of a table or a meta-analysis database. Such research data may then be imported into the normative database 102 to provide additional data points to be used.

The curation process for adding existing data to the normative database is an ongoing process that may occur each time new data is released or gathered.

The normative database 102 may be implemented using any known database structure, such as a relational database, a SQL database, or the like. The normative database may be accessed through a graphical user interface and may be queried using known database queries to access the data stored in the database. The normative database 102 may be implemented as one or more servers, either located on-premises or in the cloud as one or more logical servers. The servers may be run with one or more processors that perform the operations as described herein.

The exemplary normative database may be used to provide users with estimates of advertising elasticity for a given advertising activity. For example, assume a user wants to determine the advertising elasticity of a proposed new advertising campaign using video that will be deployed over numerous social media channels. In such an example, the user may query the normative database using the tags “video” and “social media.” The normative database determines an advertising elasticity for that particular query. This is accomplished by calculating a probability distribution of the advertising elasticity based on the existing records in the normative database that include the user-provided tags. The probability distribution may be estimated by using the average and standard deviation or percentiles of the mean elasticity, or by using regression analysis with user-provided tags as covariates. Thus, the normative database returns the calculated mean and standard deviation values that represent the expected advertising elasticity, which is determined based on the records 104 in the normative database that include the tags “video” and “social media.”

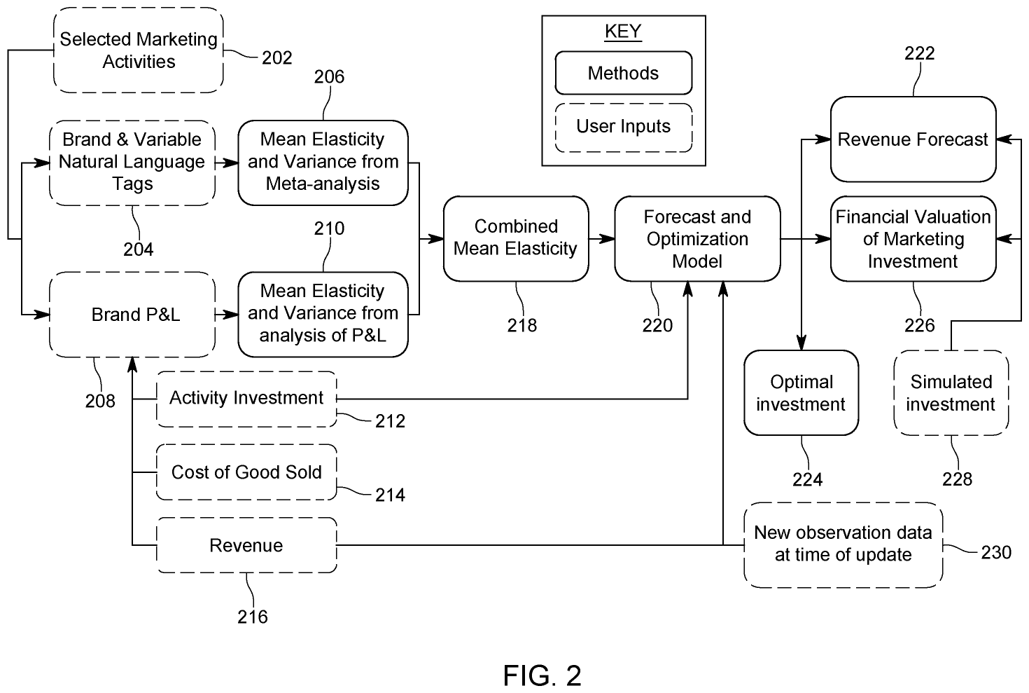

In the context of the quick-start method described herein, the normative database is used to provide a user with an estimate of advertising elasticity for the offering (e.g., brand or product) being analyzed. That estimated advertising elasticity for the offering is provided as an input to the quick-start method, as explained below in more detail in the context of FIG. 2. The calculated mean and standard deviation values for advertising elasticity that are returned from the normative database as part of the meta-analysis are used as an input into the quick-start method described herein.

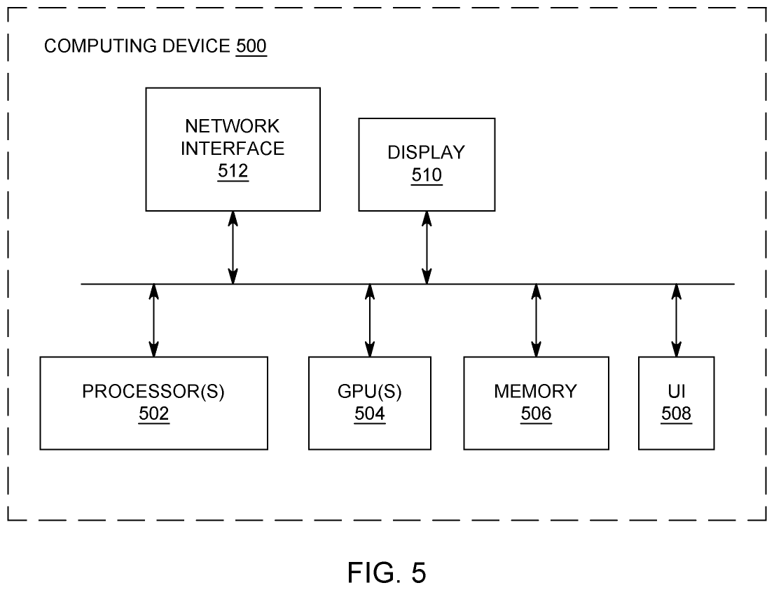

FIG. 2 depicts an exemplary process flow for a method of generating an allocation of resources to a total marketing budget for a particular offering. The method described in the context of FIG. 2 may be implemented by at least one processor or other circuitry in a computing device such as the exemplary computing device shown in FIG. 5 or a system comprising one or more computing devices such as the exemplary device shown in FIG. 5.

As noted above, advertising elasticity refers to an expected proportional change in revenue for a proportional change in investment in a marketing activity 202. The quick-start method described herein uses two separate measures of advertising elasticity to generate an optimal investment allocation. The first measure of advertising elasticity is generated from the brand and variable natural-language tags 204 that are stored in the normative database 102 (as described above in the context of FIG. 1), and the second measure of advertising elasticity is generated from the brand financial or profit-and-loss data 208, which is provided by the user.

The advertising elasticity is used together with marketing activity data in a forecast and optimization model. The forecast and optimization model produces a forecast of the revenue, present value, net present value (NPV) calculated as the difference between the present value and the investment, marginal return on investment (mROI), and a plurality of marketing response metrics, all calculated as a function of the advertising elasticity associated with the marketing tactic or activity. In the optimization, the NPV is used as the objective function and the mROI provides a measure of the incremental present value for an incremental unit of investment.

The first measure of advertising elasticity is generated using normative data provided from the normative database 102 as results from a meta-analysis, as described in the context of FIG. 1. The input from the normative database is represented as the “brand & variable natural language tags” block 204 in FIG. 2.

For the advertising elasticity to be generated using normative data, the quick-start method receives user input summarizing the selected marketing activity 202 being analyzed (e.g., brand or product), which may also be referred to as a marketing tactic or a variable. The user input may represent a natural-language tag for the variable. The selected marketing activities may be input at any level of granularity (e.g., brand level, national level, description of tactics, etc.). The brand may be broken down further, for example, into the SKU level. Similarly, the national level may be broken down further, for example into the geographic level. The tactics may be broken down into deeper levels of execution. For example, a tactic may focus on branded keywords vs. unbranded keywords, or top of the funnel vs. bottom of the funnel. The keywords may be broken down further into groups of keywords, specific keywords, etc.

The natural-language tags for the brand may include the industry, the category (e.g., sweet snacks, salty snacks, breakfast cereal, protein, vegetable, etc.), the type of distribution (e.g., online vs. offline), and descriptors of the brand (e.g., where the brand is in the lifecycle, whether the brand is a new or established brand, whether the brand is a market leader, the pricing of the brand, etc.).

The natural-language tags for variables may include one or more words or phrases that describe the marketing tactic. For example, the tags may include the name of the tactic, a description of the tactic, the name of the specific media execution site (e.g., Facebook, Instagram, Snapchat, etc.).

Once the user has input the brand and variable natural language tags, a first measure of mean value and the variance of the advertising elasticity is determined for the natural language tags using a meta-analysis, as shown at block 206. The meta-analysis may be performed using one or more statistical models, such as regression and probability models. The meta-analysis is performed using the normative database 102 (e.g., the exemplary normative database of FIG. 1), which includes data from models that have been gathered from various users of the system and/or data provided as part of academic literature.

In addition to the brand and variable natural language tags, the quick-start method described herein also receives as input financial data. The financial data may be for the offering related to the marketing variable. The financial data may come, for example, from the brand's profit and loss statement. In particular, the financial data includes revenue 216, cost of goods sold 214 (e.g., production costs), and activity investment 212 (e.g., marketing investment) to achieve the provided revenue. The input from the financial data is represented as the “brand P&L” block 208 in FIG. 2. The quick-start method uses the brand's financial data, such as the profit and loss data 208, to adjust the normative meta-analysis.

The brand profit and loss 208 refers to an amount of financial data related to marketing activities. The level of granularity of the brand P&L may vary based on the type of marketing tactic. For example, the marketing financial data may include financial data across the entire business, the entire brand, or the like. The data that makes up the brand P&L may include, for example, historical revenue 216 for the brand, cost of goods sold 214 for the brand, and expenditure 212 by tactic for the brand.

The brand profit and loss statements are generally more readily available to the user and generally less burdensome to the user to input into the computer system than historical time-series data and/or survey data. Because of this, the quick-start method described herein and the corresponding computer system that implements the quick-start method described herein provide a practical application that generates new data for the user more quickly, more efficiently, and in more possible situations than previous methods and/or computer systems attempting to accomplish the same thing using historical time-series data and/or survey data.

The quick-start method infers the elasticity from the financial data. This yields a second measure of advertising elasticity based on the brand P&L data, characterized as a normal probability distribution by the mean and variance, as shown at block 210.

The inferences are derived by the quick-start method by treating the elasticity as the unknown in the forecast and optimization model. The quick-start method infers the advertising elasticity by finding the elasticity that maximizes the NPV subject to the constraints that (1) expected revenue is equivalent to the historical revenue from the brand P&L; and (2) the marginal return relative to the marginal cost is a value of 1.

Once the first measure of mean and variance of advertising elasticity 206 (i.e., based on the brand and variable natural language tags) and the second measure of mean and variance of advertising elasticity 210 (i.e., based on the brand P&L) have been determined, the two measures of mean and variance of advertising elasticity are combined into a single distribution of expected advertising elasticity and variance, as shown at block 218. The two measures of mean and variance of advertising elasticity are combined using conjugate Bayesian methods for combining two normal distributions.

The forecast and optimization model is built, as shown at block 220, with the combined mean advertising elasticity 218, the activity investment data 212 from the brand P&L data, and the historical revenue data 216 from the brand P&L data.

The updated forecast and optimization model 220 is used to generate a revenue forecast 222, a financial valuation of the marketing investment 226, and an investment recommendation for the optimal investment amount 224 for each marketing tactic.

Different optimization constraints may be applied in determining the optimal investment recommendation 224. For example, fixed total budget, a minimum and/or maximum investment for each marketing activity, the timing of the investment, and/or an output constraint for the revenue (e.g., a revenue target).

A user may generate a revenue forecast 222 and a financial valuation for a specific activity 226 using the updated forecast and optimization model by inputting a simulated investment value 228 for the specific marketing activity to the model.

Once the updated forecast and optimization model has been generated, the user may also update the model with new time-series data 230. This adjusts the model to be more consistent with the new time-series data provided.

The quick-start method described herein generates an econometric model as output. This output econometric model is represented as the “forecast and optimization model” block 220 shown in FIG. 2. The econometric model 220 generates output data and can be used to create simulations that are based on any budget and/or allocation of budget. The generated econometric model may take input data and generate output data, which includes metrics such a NPV, ROI, and revenue forecast. The generated econometric model further provides optimization utilities that provide allocations for maximizing NPV, hitting a particular revenue target, or a meeting a particular budgeting constraint.

As further shown in FIG. 2, this output econometric model 220 may be later validated and/or updated with observation data 230 (e.g., the historical time-series data and/or survey data that was initially not needed or used for the modeling process), represented as the “new observation data at time of update” block 230 in FIG. 2. The second piece of output data is the optimal allocation of marketing investment 224. This optimal allocation of marketing investment is represented as the “optimal investment” block 224 in FIG. 2. The third piece of output data is a forecast 222 associated with the optimal allocation of marketing investment. This forecast is represented as the “revenue forecast” block 222 in FIG. 2. The fourth piece of output data is a projected value of the marketing investment 226. This projected value of the marketing investment is represented as the “financial valuation of marketing investment” block 226 in FIG. 2. The projected value of the marketing investment includes, for example, the long-term value of a particular marketing investment.

The quick-start method described herein uses financial information to make brand-specific adjustments. The brand-specific adjustments recognize that the previous allocation of investment provides additional information that can be used to estimate advertising elasticity. The brand-specific adjustments can be used to size the elasticity relative to revenue and increases the accuracy of the optimal level, mix, and forecast.

The methods described herein, including the quick-start method described in the context of FIG. 2, may be performed by a computer system comprising one or more processors for executing the methods described herein. The computer system may further comprise memory that stores the normative database 102 described herein. The computer system may further comprise a graphical user interface for allowing users to interact with the normative database, for example, to receive user input such as a description of the offering being analyzed and/or the brand's financial data.

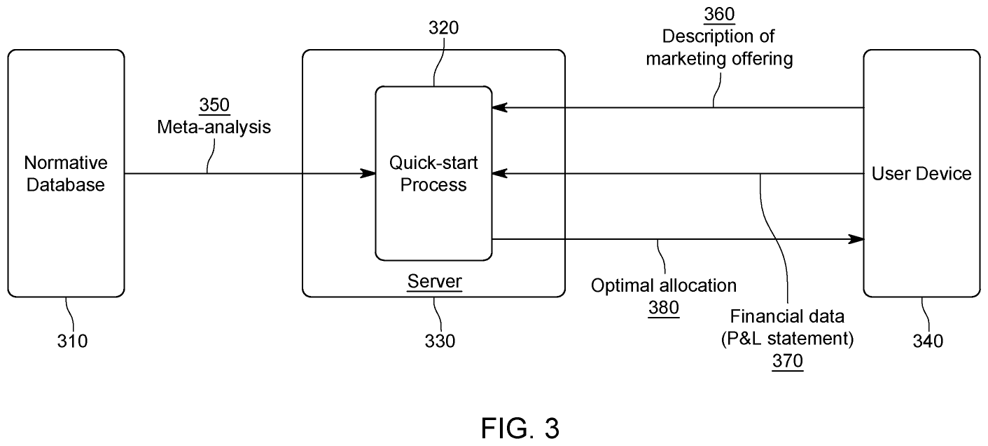

FIG. 3 depicts an exemplary system for implementing the method described in FIG. 2.

As shown in FIG. 3, a user inputs a description of a marketing offering 360 and financial data 370 to the quick-start process 320. This may be accomplished via a user device 340 (e.g., a personal computing device, such as a desktop computer, a laptop computer, or a mobile device such as an Apple iOS-based device or a Google Android-based device) communicatively connected to a back-end server 330 over the Internet. The user device 340 may be a computing device such as the exemplary computing device shown in FIG. 5. The user may input the information to the user device via a graphical user interface that allows the user to input the required information. The back-end server 330 may be a cloud-based server (e.g., provided by Amazon Web Services, Microsoft Azure, or the like), or it may be a physical server located in-house. The back-end server 330 is communicatively coupled to the normative database 310. The normative database 310 may be a separate physical component, or it may be a component of the back-end server 330. The quick-start process 320 provides an advertising elasticity engine, which may be a software component running on one or more processors within the back-end server 330. The quick-start process 320 receives meta-analysis information 350 from the normative database 310 based on the user-input description of the marketing offering 360, as described in the context of FIG. 2. The quick-start process 320 uses the meta-analysis information 350 from the normative database 310 and the user-input financial data 370 to produce computer-readable data that can be used to generate the optimal allocation 380 of marketing budget, as described in the context of FIG. 2. The optimal allocation 380 is provided to the user device 340.

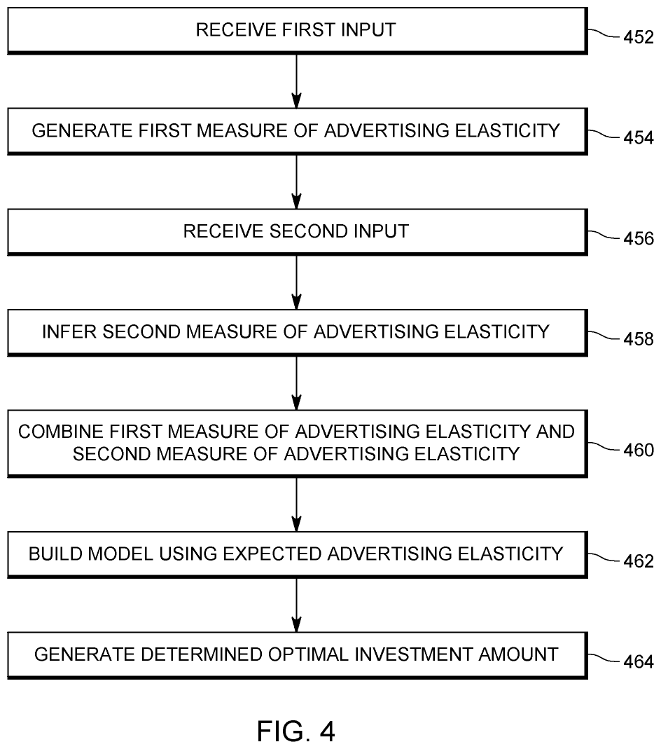

FIG. 4 depicts an exemplary process flow for a method of generating an allocation of marketing investment for a marketing budget based on a marketing variable without requiring historical time-series data or survey data for the marketing variable. The method described in the context of FIG. 4 may be implemented by at least one processor or other circuitry in a computing device such as the exemplary computing device shown in FIG. 5 or a system comprising one or more computing devices such as the exemplary device shown in FIG. 5.

At step 452, the method receives a first input from a user. The first input represents a natural-language tag for the marketing variable. In some embodiments, the first input from the user summarizes the marketing variable. For example, in some embodiments, the first input from the user describes a brand, a product, or a marketing tactic. The first input from the user may be a keyword that describes the marking variable. The first input from the user may be received via computing device through a graphical user interface, or it may be received as a file, such as an Excel, .csv, or .pdf file, that is read electronically as part of the method. Additionally, the first input from the user may be received as an existing data object that is exported from an existing database or advertising modeling software system.

At step 454, the method generates a first measure of advertising elasticity. The first measure of advertising elasticity is calculated based on the natural-language tag for the marketing variable using a normative database. In some embodiments, the first measure of advertising elasticity is generated using normative data from the normative database. In some embodiments, the first measure of advertising elasticity is generated as a mean value and a variance of determined by performing a meta-analysis on normative data from the normative database. The meta-analysis is performed on the normative data from the normative database using a statistical model.

At step 456, the method receives a second input from the user. The second input represents financial data for an offering related to the marketing variable. The financial data represented by the second input received from the user includes profit-and-loss data. The financial data may include a revenue number, a cost of goods sold number, and an activity investment number associated with the revenue number. The second input from the user may be received via computing device through a graphical user interface, or it may be received as a file, such as an Excel, .csv, or .pdf file, that is read electronically as part of the method. Additionally, the second input from the user may be received as an existing data object that is exported from an existing database or financial software system.

At step 458, the method infers a second measure of advertising elasticity based on the received financial data. In some embodiments, the second measure of advertising elasticity is inferred by determining an advertising elasticity that maximizes the NPV based on a constraint.

At step 460, the method combines the first measure of advertising elasticity and the second measure of advertising elasticity into a single distribution to generate an expected advertising elasticity. The first measure of advertising elasticity and the second measure of advertising elasticity are combined using conjugate Bayesian methods for combining two normal distributions.

At step 462, the method builds a model with the expected advertising elasticity and the financial data. The built model represents the net present value (NPV) of cash flow and expected revenue originating from an expenditure associated with the marketing variable. The NPV and expected revenue are determined as a function of the advertising elasticity associated with the marketing variable and the financial data. The built model is an output data object that can be used to generate the optimal allocation of marketing budget, as described in the context of FIGS. 2 and 3.

At step 464, the method generates an output value that represents a determined optimal investment amount. The output value is generated using the built model.

In some embodiments, the method further generates a revenue forecast for the determined optimal investment amount using the built model. In some embodiments, the method further generates a financial valuation of the determined optimal investment amount using the built model. In some embodiments, the method further generates an investment recommendation for the determined optimal investment amount using the built model. The built model may be stored for later use and/or re-use, without needing to rebuild it for future uses. Alternatively, the built model may be further updated in the future using additional new information.

FIG. 5 depicts a block diagram illustrating one embodiment of a computing device that implements the methods and systems for generating an optimal allocation of marketing investment described herein.

Referring to FIG. 5, the computing device 500 may include at least one processor 502, at least one graphical processing unit (“GPU”) 504, at least one memory 506, a user interface (“UI”) 508, a display 510, and a network interface 512. The memory 506 may be partially integrated with the processor(s) 502 and/or the GPU(s) 504. The UI 508 may include a keyboard and a mouse. The display 510 and the UI 508 may provide any of the GUIs in the embodiments of this disclosure.

As will be appreciated by one skilled in the art, aspects of the technology described herein may be embodied as a system, method or computer program product. Accordingly, aspects of the technology may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the technology may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the technology described herein may be written in any combination of one or more programming languages, including object oriented and/or procedural programming languages. Programming languages may include, but are not limited to: Ruby®, JavaScript®, Java®, Python®, PHP, C, C++, C#, Objective-C®, Go®, Scala®, Swift®, Kotlin®, OCaml®, or the like. The program code may execute entirely on the user's computer, partly on the user's computer, as a stand-alone software package, partly on the user's computer, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the technology described herein refer to flowchart illustrations and/or block diagrams of methods, apparatus (systems) and computer program products according to various embodiments. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the technology described herein. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting. As used herein, the singular forms “a,” “an” and “the” are intended to include the plural forms as well, unless the context clearly indicates otherwise. Thus, for example, reference to “a user” can include a plurality of such users, and so forth. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description provided herein has been presented for purposes of illustration and description, but is not intended to be exhaustive or limited to the specific form disclosed. Many modifications and variations will be apparent to those of ordinary skill in the art without departing from the scope and spirit of the disclosure. The embodiment was chosen and described in order to best explain the principles described herein and the practical application of those principles, and to enable others of ordinary skill in the art to understand the technology for various embodiments with various modifications as are suited to the particular use contemplated.

The descriptions of the various embodiments of the technology disclosed herein have been presented for purposes of illustration, but these descriptions are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for generating an allocation of marketing investment for a marketing budget based on a marketing variable without requiring historical time-series data or survey data for the marketing variable, the method comprising:
receiving a first input from a user, wherein the first input represents a natural-language tag for the marketing variable;
generating a first measure of advertising elasticity, wherein the first measure of advertising elasticity is calculated based on the natural-language tag for the marketing variable using a normative database;
receiving a second input from the user, wherein the second input represents financial data for an offering related to the marketing variable;
inferring a second measure of advertising elasticity based on the received financial data;
combining the first measure of advertising elasticity and the second measure of advertising elasticity into a single distribution to generate an expected advertising elasticity;
building a model with the expected advertising elasticity and the financial data; and
generating, using the built model, an output value that represents a determined optimal investment amount.

2. The method of claim 1, wherein the first measure of advertising elasticity is generated using normative data from the normative database.

3. The method of claim 1, wherein the first input from the user summarizes the marketing variable.

4. The method of claim 1, wherein the first input from the user describes a brand, a product, or a marketing tactic.

5. The method of claim 1, wherein the first input from the user is a keyword that describes the marking variable.

6. The method of claim 1, wherein the financial data represented by the second input received from the user includes profit-and-loss data.

7. The method of claim 1, wherein the first measure of advertising elasticity is generated as a mean value and a variance of determined by performing a meta-analysis on normative data from the normative database.

8. The method of claim 7, wherein the meta-analysis is performed on the normative data from the normative database using a statistical model.

9. The method of claim 1, wherein the financial data includes a revenue number, a cost of goods sold number, and an activity investment number associated with the revenue number.

10. The method of claim 1, wherein the built model represents the net present value (NPV) of cash flow and expected revenue originating from an expenditure associated with the marketing variable.

11. The method of claim 10, wherein the NPV and expected revenue are determined as a function of the advertising elasticity associated with the marketing variable and the financial data.

12. The method of claim 1, wherein the second measure of advertising elasticity is inferred by determining an advertising elasticity that maximizes the NPV based on a constraint.

13. The method of claim 1, wherein the first measure of advertising elasticity and the second measure of advertising elasticity are combined using conjugate Bayesian methods for combining two normal distributions.

14. The method of claim 1, further comprising generating a revenue forecast for the determined optimal investment amount, generating a financial valuation of the determined optimal investment amount, or generating an investment recommendation for the determined optimal investment amount.

15. A system for generating an allocation of marketing investment for a marketing budget based on a marketing variable without requiring historical time-series data or survey data for the marketing variable, the system comprising:
a normative database; and
a back-end server communicatively coupled to the normative database, the back-end server comprising a processor configured for:
receiving a first input from a user, wherein the first input represents a natural-language tag for the marketing variable;
generating a first measure of advertising elasticity, wherein the first measure of advertising elasticity is calculated based on the natural-language tag for the marketing variable using the normative database;
receiving a second input from the user, wherein the second input represents financial data for an offering related to the marketing variable;
inferring a second measure of advertising elasticity based on the received financial data;
combining the first measure of advertising elasticity and the second measure of advertising elasticity into a single distribution to generate an expected advertising elasticity;
building a model with the expected advertising elasticity and the financial data; and
generating, using the built model, an output value that represents a determined optimal investment amount.

16. The system of claim 15, wherein the first measure of advertising elasticity is generated using normative data from the normative database.

17. The system of claim 15, wherein the first input from the user summarizes the marketing variable.

18. The system of claim 15, wherein the first input from the user describes a brand, a product, or a marketing tactic.

19. The system of claim 15, wherein the first input from the user is a keyword that describes the marking variable.

20. The system of claim 15, wherein the financial data represented by the second input received from the user includes profit-and-loss data.

21. The system of claim 15, wherein the first measure of advertising elasticity is generated as a mean value and a variance of determined by performing a meta-analysis on normative data from the normative database.

22. The system of claim 15, wherein the meta-analysis is performed on the normative data from the normative database using a statistical model.

23. The system of claim 15, wherein the financial data includes a revenue number, a cost of goods sold number, and an activity investment number associated with the revenue number.

24. The system of claim 15, wherein the built model represents the net present value (NPV) of cash flow and expected revenue originating from an expenditure associated with the marketing variable.

25. The system of claim 24, wherein the NPV and expected revenue are determined as a function of the advertising elasticity associated with the marketing variable and the financial data.

26. The system of claim 15, wherein the second measure of advertising elasticity is inferred by determining an advertising elasticity that maximizes the NPV based on a constraint.

27. The system of claim 15, wherein the first measure of advertising elasticity and the second measure of advertising elasticity are combined using conjugate Bayesian methods for combining two normal distributions.

28. The system of claim 15, wherein the processor is further configured for generating a revenue forecast for the determined optimal investment amount, generating a financial valuation of the determined optimal investment amount, or generating an investment recommendation for the determined optimal investment amount.
